(19) United States
(12) Patent Application Publication
(10) Pub. No.: US 2025/0191282 A1
(43) Pub. Date: Jun. 12, 2025

(54) ADAPTIVE SAMPLING OF LOCATIONS IN A SCENE

(71) Applicant: Microsoft Technology Licensing, LLC, Redmond, WA (US)

(72) Inventors: John Michael SNYDER, Redmond, WA (US); Nikunj RAGHUVANSHI, Redmond, WA (US); Michael G. CHEMISTRUCK, Issaquah, WA (US)

(73) Assignee: Microsoft Technology Licensing, LLC, Redmond, WA (US)

(21) Appl. No.: 18/531,336

(22) Filed: Dec. 6, 2023

(51) Int. Cl. G06T 15/50; H04N 13/351

(52) U.S. Cl. CPC G06T 15/506; H04N 13/351

(57) ABSTRACT

The description relates to adaptive sampling of three-dimensional virtual scenes. For instance, sampling assignments can be determined based on an energy propagation variation field having energy propagation variation values indicating rates at which energy propagation changes as a function of location within a three-dimensional synthetic scene. Sampling probes can be deployed according to the sampling assignments, and then each sampling probe can be employed to simulate energy propagation within the three-dimensional synthetic scene. The simulations can produce parameters suitable for subsequent rendering of energy signals for applications such as video games.

### BACKGROUND

There are many applications where it is useful to sample energy propagation in a three-dimensional scene, e.g., to determine characteristics of light, sound, or radio waves travelling in the scene. One approach is to uniformly sample the space at regular intervals, e.g., taking one sample for every cubic meter, every 10 cubic meters, etc. However, uniform sampling does not account for characteristics of the environment such as the presence of obstructions that can influence the paths that energy takes when travelling in the scene. Furthermore, uniform sampling does not account for situations where certain locations in a scene may be relatively more important to sample because of user behavior.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The description generally relates to adaptive sampling of locations in a scene. One example includes a computer-implemented method including obtaining an energy propagation variation field having energy propagation variation values indicating rates at which energy propagation changes as a function of location within a three-dimensional synthetic scene. The method can also include selecting a plurality of sampling assignments within the three-dimensional synthetic scene based at least on the energy propagation variation field. The method can also include deploying sampling probes within the three-dimensional synthetic scene according to the plurality of sampling assignments. The method can also include performing simulations of energy propagation within the three-dimensional synthetic scene using the deployed sampling probes. The method can also include obtaining results of the simulations. The method can also include storing parameters corresponding to the results of the simulations, the parameters providing a basis for subsequent rendering of an energy signal within the three-dimensional synthetic scene.

Another example can include a system including a processor and storage storing computer-readable instructions. When executed by the processor, the computer-readable instructions cause the system to receive an input signal having a source location in a three-dimensional synthetic scene. When executed by the processor, the computer-readable instructions cause the system to access parameters that convey characteristics of energy propagation within in the three-dimensional synthetic scene, the parameters having been obtained by simulating energy propagation at sampled locations in the three-dimensional synthetic scene, the sampled locations being located based at least on an energy propagation variation field and an importance field. When executed by the processor, the computer-readable instructions cause the system to render an energy signal at a receiver location based at least on the parameters.

Another example can include a computer-readable medium storing executable instructions which, when executed by a processor, cause the processor to perform acts. The acts can include obtaining an energy propagation variation field having energy propagation variation values indicating rates at which energy propagation changes as a function of location within a three-dimensional synthetic scene. The acts can also include selecting a plurality of sampling assignments within the three-dimensional synthetic scene based at least on the energy propagation variation field. The acts can also include deploying sampling probes within the three-dimensional synthetic scene according to the plurality of sampling assignments. The acts can also include performing simulations of energy propagation within the three-dimensional synthetic scene using the sampling probes. The acts can also include obtaining results of the simulations. The acts can also include storing parameters corresponding to the results of the simulations, the parameters providing a basis for subsequent rendering of energy within the three-dimensional synthetic scene.

The above-listed examples are intended to provide a quick reference to aid the reader and are not intended to define the scope of the concepts described herein.

### BRIEF DESCRIPTION OF THE DRAWINGS

The accompanying drawings illustrate implementations of the concepts conveyed in the present document. Features of the illustrated implementations can be more readily understood by reference to the following description taken in conjunction with the accompanying drawings. Like reference numbers in the various drawings are used wherever feasible to indicate like elements. In some cases, parentheticals are utilized after a reference number to distinguish like elements. Use of the reference number without the associated parenthetical is generic to the element. Further, the left-most numeral of each reference number conveys the FIG. and associated discussion where the reference number is first introduced.

FIGS. 1A, 1B, and 1C illustrate examples relating to energy propagation near an inside corner, consistent with some implementations of the present concepts.

FIGS. 2A, 2B, and 2C illustrate examples relating to energy propagation near a portal, consistent with some implementations of the present concepts.

FIGS. 3A, 3B, and 3C illustrate examples relating to energy propagation near an outside corner, consistent with some implementations of the present concepts.

FIG. 4A illustrates an example of uniform sampling of a three-dimensional virtual scene, consistent with some implementations of the present concepts.

FIG. 4B illustrates an example of adaptive sampling of a three-dimensional virtual scene, consistent with some implementations of the present concepts.

FIG. 5 illustrates an example of a structure in a three-dimensional virtual scene, consistent with some implementations of the present concepts.

FIG. 6A illustrates an example of a two-dimensional importance weighting field, consistent with some implementations of the present concepts.

FIG. 6B illustrates an example of a two-dimensional energy propagation variation field, consistent with some implementations of the present concepts.

FIG. 7A illustrates an example of an initial set of sampling assignments, consistent with some implementations of the present concepts.

FIGS. 7B, 7C, and 7D illustrate examples of final sets of sampling assignments at different granularities, consistent with some implementations of the present concepts.

FIG. 8 illustrates an example system that is consistent with some implementations of the present concepts.

FIGS. 9 and 10 are flowcharts of example methods in accordance with some implementations of the present concepts.

### DETAILED DESCRIPTION

### Overview

As noted above, uniform sampling of energy propagation in a three-dimensional scene does not account for factors such as user behavior or obstructions in the scene that influence energy propagation. One way to ensure that all locations are adequately sampled is to simply increase the sampling resolution, e.g., instead of uniformly sampling every 10 square meters, uniformly sample every square meter. While this approach can ensure that all locations are adequately sampled to derive characteristics of energy propagation within the scene, it can be inefficient in terms of computational resources, such as processing resources employed to simulate energy propagation at each sampled location or memory/storage resources employed to store results of the simulations.

The disclosed implementations can overcome these deficiencies of conventional sampling approaches by adaptively sampling a scene according to several criteria. First, instead of employing a Euclidean distance for the purpose of spacing samples, the disclosed implementations can consider geodesic distance between two points when selecting sampling locations, e.g., the path that energy travels around obstacles in the space to/from the sampled locations. Second, the disclosed implementations can consider the relative importance of each location in the scene, e.g., each location can be weighted based on the likelihood that a user will be present at that location. Importance weighting ensures that areas that users frequently occupy are sampled at a higher density than areas that users never or infrequently occupy.

The techniques described herein can be employed to sample real or virtual scenes for a wide range of applications. The examples set forth below focus initially on how acoustic probes can be deployed to simulate and parameterize sound travel in a given scene for subsequent rendering of sound. However, the techniques described herein can be readily extended to other types of energy, such as deploying light probes to simulate and parameterize light propagation for subsequent rendering of graphics.

### Terminology

As used herein, the term “geometry” refers to structures (e.g., physical or virtual objects) in a scene. The term “scene” is used herein to refer to any physical, augmented, or virtual environment, and a “synthetic” scene is a digital representation of a scene. For instance, a synthetic representation of a physical scene (e.g., an auditorium, a sports stadium, a concert hall, etc.) can be obtained by measuring structures in the scene and reconstructing a digital representation of the physical scene from the measurements. Video games and virtual reality applications can incorporate virtual scenes that are entirely fictional or based on actual physical scenes.

The geometry of a scene includes any structure that affects the propagation of energy within the scene. For instance, walls can cause occlusion, reflection, diffraction, and/or scattering of sound, etc. Some additional examples of structures that can affect energy propagation are furniture, floors, ceilings, vegetation, rocks, hills, ground, tunnels, fences, crowds, buildings, animals, stairs, etc.

The term “sampling assignment,” as used herein, refers to an indication of where sampling probes are deployed in a given synthetic scene, and which points (e.g., voxels) within the scene that each probe covers. In a uniform sampling approach, each sampling assignment can include a sampling point placed at the center of a symmetrical geometric shape, such as an octagon. In the adaptive sampling techniques described herein, sampling assignments can include irregularly-shaped Voronoi cells of points surrounding a sampling probe.

### Sound Travel Examples

The following discussion uses some examples of sound propagation to motivate the disclosed adaptive sampling techniques. For a given wave pulse introduced by a sound source into a scene, the pressure response or “impulse response” at a listener arrives as a series of peaks, each of which represents a different path that the sound takes from the source to the listener. Listeners tend to perceive the direction of the first-arriving peak in the impulse response as the arrival direction of the sound, even when nearly-simultaneous peaks arrive shortly thereafter from different directions. This is known as the “precedence effect.” After the initial sound, subsequent reflections are received that generally take longer paths through the scene and become attenuated over time.

The initial first-arriving peak takes the shortest path through the air and around geometry from a sound source to a listener in a given scene. Thus, the length of the initial sound path between any two points corresponds to the geodesic distance between those two points. The following examples illustrate that the rate at which energy propagation (such as initial sound energy) varies can change as a function of location within the scene.

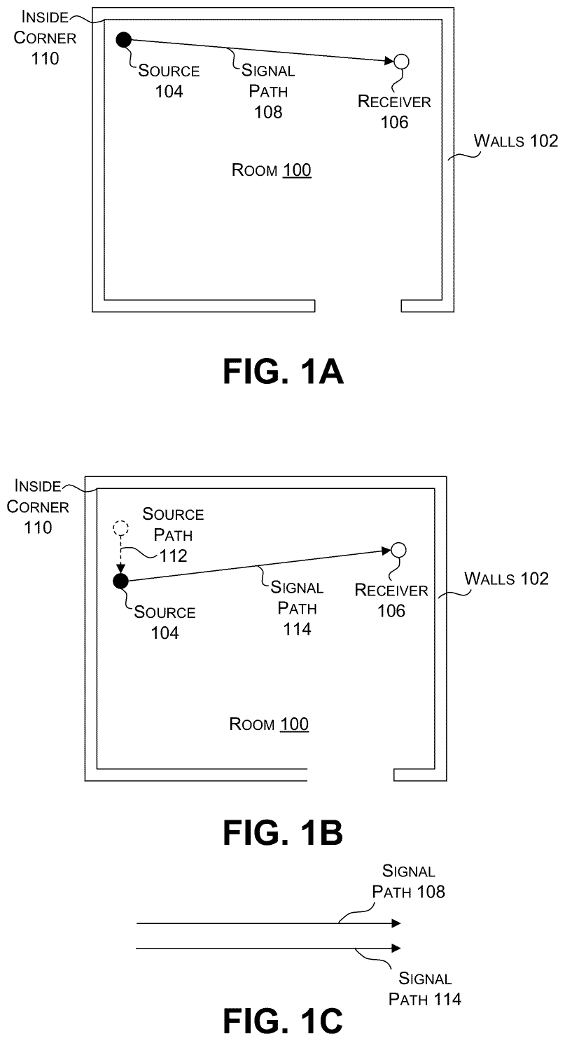

FIG. 1A shows a room 100 with walls 102. A source 104 emits a signal, such as a sound, to a receiver 106 along a signal path 108. Note source is near inside corner 110. FIG. 1B shows source 104 moving along a source path 112. A signal emitted by source 104 now follows signal path 114.

FIG. 1C shows a comparison of signal path 108 to signal path 114. Note that both signal paths have the same length. In other words, the movement of the source along source path 112 had no influence on the length of the signal path to receiver 106. More generally, movement of energy sources or energy receivers nearby inside corners tends to have very little effect on the path that energy takes when propagating from the source to the receiver.

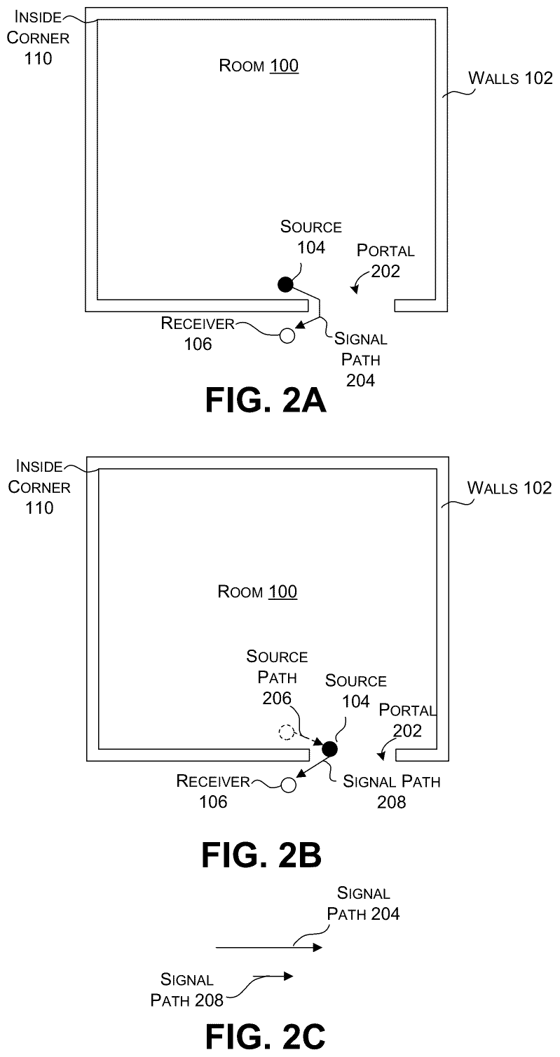

FIG. 2A shows a scenario where source 104 is located inside room 100 near a portal 202, and receiver 106 is located just outside the room near the portal. A signal from source 104 travels signal path 204 to arrive at the receiver. FIG. 2B shows source 104 moving along source path 206 to a new location. A signal emitted by the source now follows signal path 208.

FIG. 2C shows a comparison of signal path 204 to signal path 208. Note that signal path 204 is significantly longer than signal path 208. However, source path 206 is the same length as source path 112 shown in FIG. 1B. Thus, the movement of the source near portal 202 had a significant influence on the length of the signal path to the receiver, whereas the movement of the source near inside corner 110 had no influence on the length of the signal path. More generally, movement of energy sources or energy receivers near portals tends to have a significant effect on the path length that energy takes when propagating from the source to the receiver. In addition to the changes in path length illustrated in FIGS. 2A, 2B, and 2C, movement of an energy source or receiver near a portal also changes how diffracted energy is attenuated. For instance, diffraction attenuation of energy propagating through a portal changes significantly with movement around the edges or to the side of a portal relative to energy propagating straight through the portal.

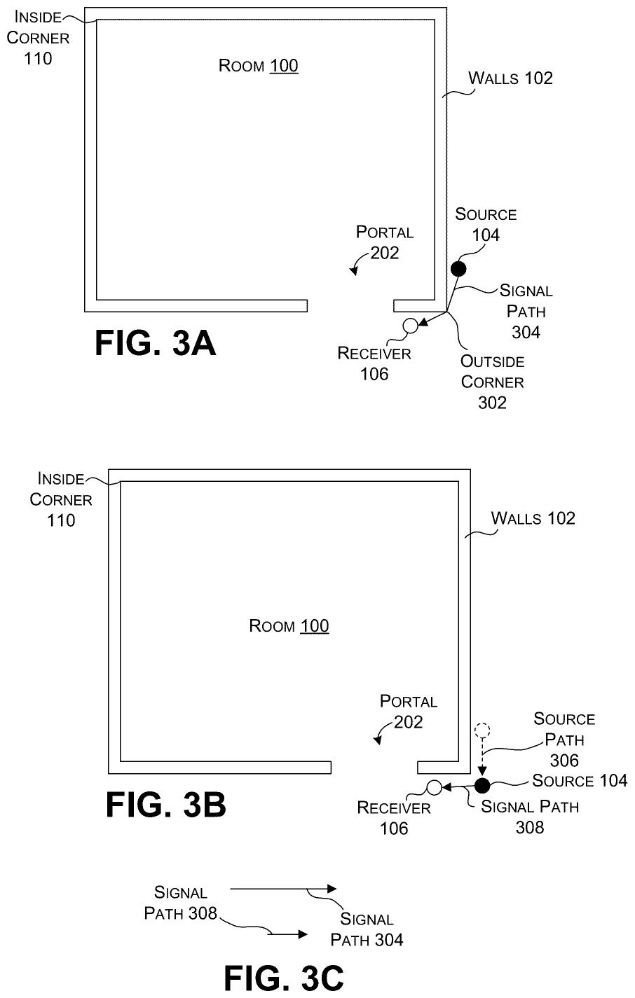

FIG. 3A shows a scenario where source 104 is located outside room 100 near outside corner 302, and receiver 106 is located just around the outside corner. A signal from source 104 travels signal path 304 to arrive at the receiver. FIG. 3B shows source 104 moving along source path 306 to a new location. A signal emitted by the source now follows signal path 308.

FIG. 3C shows a comparison of signal path 304 to signal path 308. Note that signal path 304 is significantly longer than signal path 308. However, source path 306 is the same length as source path 112 shown in FIG. 1B. Thus, the movement of the source near outside corner 302 had a significant influence on the length of the signal path to the receiver, whereas the movement of the source near inside corner 110 had no influence on the length of the signal path. More generally, movement of energy sources or energy receivers near outside corners tends to have a significant effect on the path length that energy takes when propagating from the source to the receiver. In addition to the changes in path length illustrated in FIGS. 3A, 3B, and 3C, movement of an energy source or receiver near an outside corner also changes how diffracted energy is attenuated, depending on the bend angle of the path of the energy at the occlusion point on the outside corner.

The above examples illustrate the point that energy propagation in a scene does not change uniformly as the source and receiver move relative to one another in the scene. Movement of a source or receiver near structures such as an inside corner can have very little influence on the length of a signal path and/or diffraction attenuation between the source and receiver. On the other hand, movement of the source or receiver near a portal or outside corner can have a very significant effect on the length of a signal path and/or on diffraction attenuation of energy propagating from the source to the receiver between the source and receiver.

In addition, note that the Euclidean distance between a source and receiver does not necessarily convey the length of a signal path between the source and receiver. Referring to FIG. 2A, a direct path (not shown) from source 104 through walls 102 to receiver 106 would be much shorter than signal path 204. More generally, measurements of Euclidean distance between source and receiver locations tend to be inadequate for efficient sampling of scenes with complex geometry. By using geodesic rather than Euclidean distance to inform sampling assignments within a given scene, the disclosed implementations can efficiently sample the scene by giving consideration to the effect of geometric structures such as portals and outside corners on energy propagation within the scene.

### Adaptive Sampling Example

In some implementations, simulations can be employed to model the travel of energy between selected locations in a given scene. For instance, sound sources can be deployed at given source locations and acoustic sampling probes can act as a listener at a corresponding sampled location. In some implementations, sound sources can be deployed in a three-dimensional grid of cubic voxels. For instance, each voxel can have a size of approximately one cubic meter (not shown), with one sound source per voxel. Simulations can be carried out for each combination of sound source locations and sampling probes in the scene, and the simulation results can be stored in parameter fields representing how energy propagates to each sampling probe to other locations in the space.

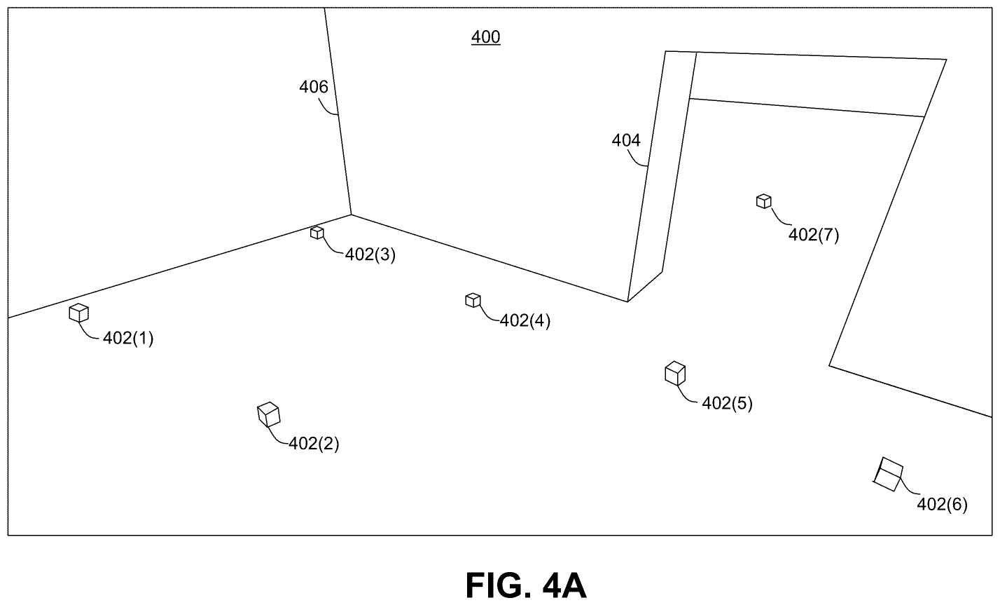

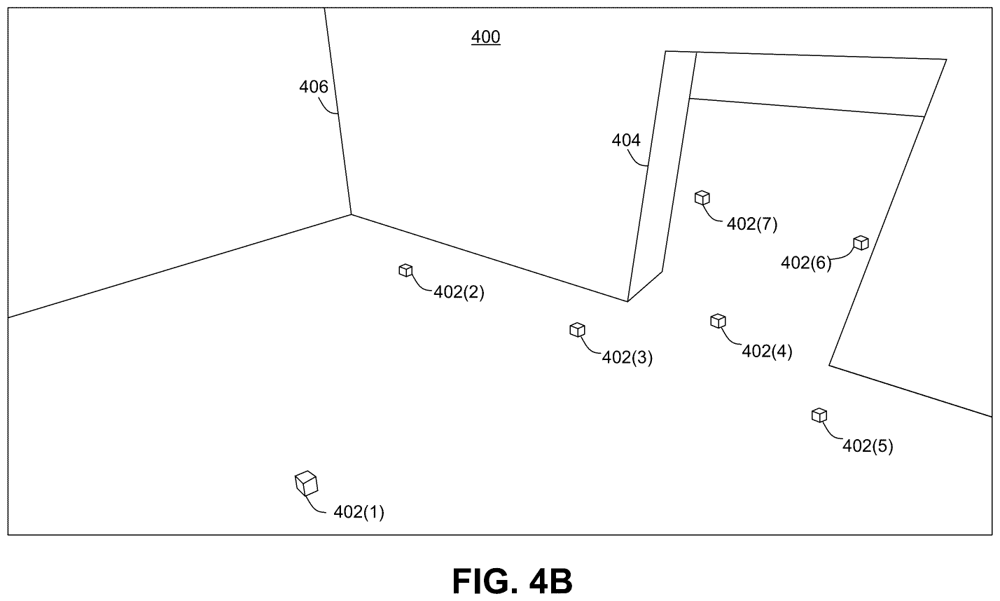

FIG. 4A shows a uniform sampling approach of a space 400. Individual probes 402(1)-402(7) are deployed throughout the scene at approximately equally-spaced intervals. Note that only two sampling probes, 402(5) and 402(7), are nearby portal 404 and the remaining sampling probes are either further away from any geometry or near an inside corner 406. However, as illustrated above, energy propagation tends to change quickly when a source or receiver moves relative to a portal, and thus two probes near portal 404 may not be sufficient to adequately sample energy propagation near the portal. On the other hand, as also illustrated previously, energy propagation tends to change more slowly in areas without geometry or near inside corners. Thus, the remaining 5 sampling probes may be more than is necessary to adequately sample the rest of space 400.

FIG. 4B shows an adaptive sampling approach where the sampling probes are non-uniformly distributed, being more concentrated near portal 404 and less concentrated near inside corner 406 and the rest of the space 400. Note that this not only accounts for the fact that variation in energy propagation is higher near portal 404, but also accounts for realistic traffic patterns by users. Generally speaking, human users or video game characters tend to funnel into portals when moving in a space, and thus it is likely that users are more likely to be found near portal 404 instead of inside corner 406.

Simulations by each sampling probe can be implemented to determine fields of one or more acoustic parameters. For instance, a 2-dimensional field can represent a horizontal “slice” within a given scene. Thus, different acoustic parameter fields can be generated for different vertical heights within a scene to create a volumetric representation of sound travel for the scene with respect to the listener location. Generally, the relative density of each encoded field can be a configurable parameter that varies based on various criteria, where denser fields can be used to obtain more accurate representations and sparser fields can be employed to obtain computational efficiency and/or more compact representations.

For instance, probes can be located more densely in spaces where scene geometry is locally complex (e.g., inside a narrow corridor with multiple portals), and located more sparsely in a wide-open space (e.g., outdoor field or meadow). In addition, vertical dimensions of the probes can be constrained to account for the height of human listeners, e.g., the probes may be instantiated with vertical dimensions that roughly account for the average height of a human being. This can be implemented using importance weighting, as described more below.

In acoustic probing implementations, parameters can include initial sound parameters representing the delay and loudness of the initial sound path, the departure direction of the initial sound path from the source, and/or the arrival direction of the initial sound path at the listener. Chaitanya, et al., “Directional sources and listeners in interactive sound propagation using reciprocal wave field coding,” ACM Transactions on Graphics (TOG), 2020, 39 (4), 44-1. Raghuvanshi, et al., “Parametric wave field coding for precomputed sound propagation,” ACM Transactions on Graphics (TOG), 2014, 33 (4), 1-11. Raghuvanshi, et al., “Parametric directional coding for precomputed sound propagation,” ACM Transactions on Graphics (TOG), 2018, 37 (4), 1-14. Raghuvanshi et al., “Bidirectional Propagation of Sound,” U.S. Patent Publication No. US20210266693 A1, published Aug. 26, 2021. Sound can be subsequently rendered at runtime based on the stored parameters.

For light probing implementations, computer graphics techniques can be employed to estimate lighting parameters at the probed locations. For instance, Metropolis light transport could be employed to simulate paths to/from the probed locations. Veach et al., “Metropolis Light Transport,” Proceedings of the 24th Annual Conference on Computer Graphics and Interactive Techniques, August 1997, pp. 65-76. The simulations could be employed to derive parameters representing intensity of different wavelengths arriving at the sampled locations, wavelength basis functions at the sampled locations, or human cone response functions at the sampled locations. These parameters can be employed at runtime to render graphics at a runtime viewer location, e.g., by interpolating the estimated lighting parameters for runtime light source and viewer locations.

### Example Scene

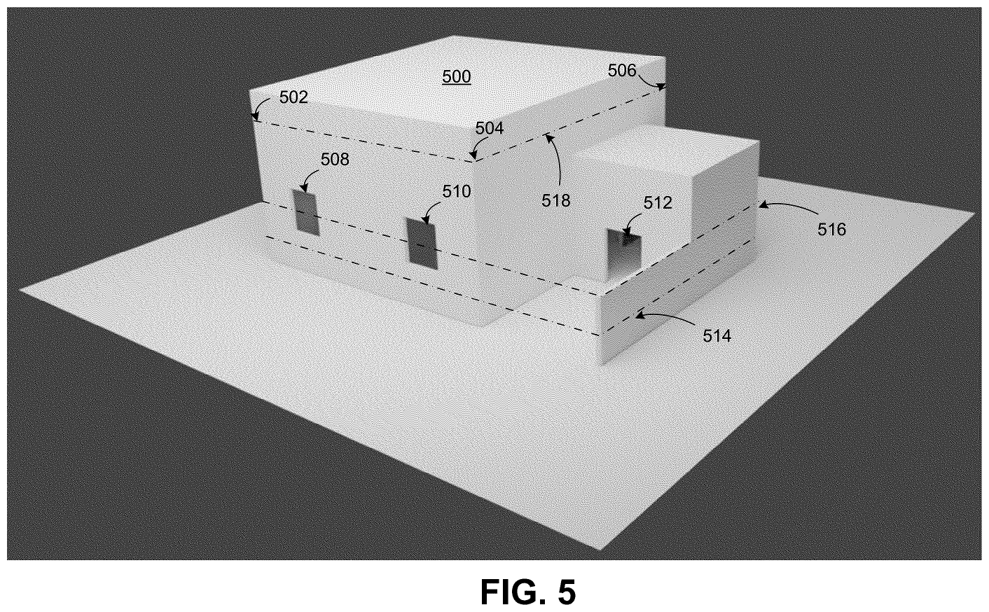

FIG. 5 illustrates a three-dimensional synthetic scene with a building 500. Outside corners 502, 504, and 506 and portals 508, 510, and 512 are visible in FIG. 5. Also shown are three planes, lower plane 514, middle plane 516, and upper plane 518. The following examples employ lower plane 514 to illustrate certain concepts. Note that lower plane 514 intercepts portal 512, but not portals 508 and 510.

One way to determine where to place sampling probes involves using three-dimensional input fields representing a given scene. Each three-dimensional input field can include a stack of two-dimensional fields, each representing a two-dimensional horizontal slice of a scene. The following provides two examples of input fields that can be employed to inform sampling assignments.

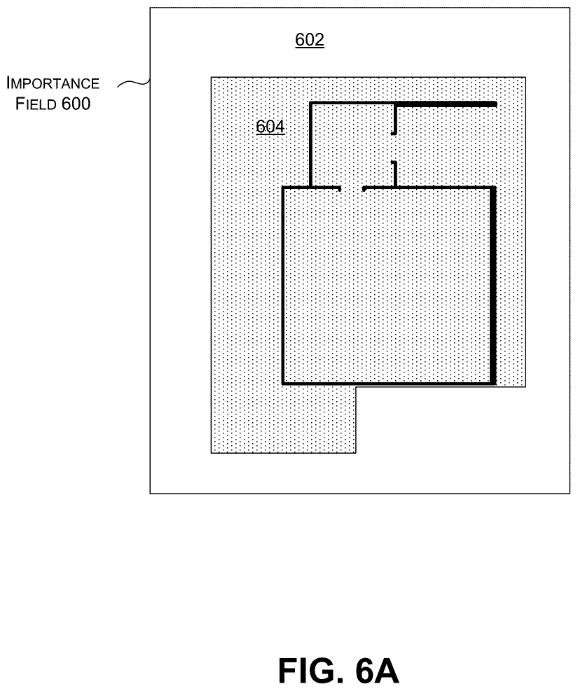

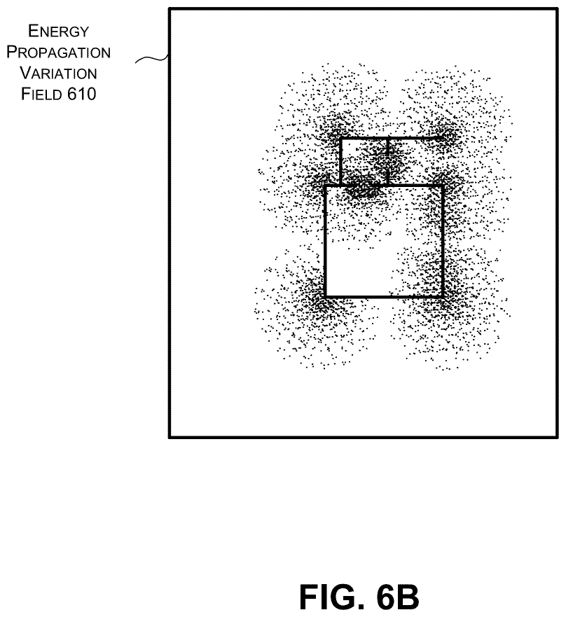

FIG. 6A shows an example importance field 600. Area 602 is shown in white and represents areas where users are unlikely to be at runtime. For instance, area 602 could have an importance weight of 0.2, e.g., for a video game application, a probability of a user occurring in area 602 during an hour of gameplay could be 20%. Area 604 is shown in shading and represents areas where users are more likely to be at runtime. For instance, area 604 could have an importance weight of 0.8, e.g., for a video game application a probability of a user occurring in area 604 during an hour of gameplay could be 80%.

FIG. 6B shows an example energy propagation variation field 610. Areas of denser stippling represent areas where energy propagation changes rapidly with movement of the source or listener, e.g., near portals and outside corners. Areas with sparser stippling represent areas where energy propagation changes slowly with movement of the source or listener. Thus, areas with denser stippling convey areas where the values in the energy propagation variation field are relatively higher.

While not shown in FIGS. 6A and 6B, corresponding importance and metric fields can be provided for each horizontal slice in the scene. For instance, the importance field can include relatively higher values at heights where a human head is likely to occur, e.g., to model the probability that a user will be listening at a given location. Likewise, a two-dimensional energy propagation variation field representing middle plane 516 could have relatively higher values in a vicinity of portals 508 and 510 than shown in FIG. 6B, since these two portals are intercepted by the middle plane but not the lower plane 514 represented by FIG. 6B.

### Specific Algorithm

One way to adaptively sample a space is to formulate the problem as seeking n optimal sample points or sampling probe locations, Pᵢ: i∈[1,n], which minimize an integrated, importance-weighted distance squared defined as:

$${d}_{v}^{2} ( \{ {P}_{i} \} ) ≡ {\sum }_{i = 1}^{n} {\int }_{𝒞 ( {P}_{i} )} {d}^{2} ( p , {P}_{i} ) d v = {\sum }_{i = 1}^{n} ( {\sum }_{{p}_{i j} ∈ 𝒞 ( {P}_{i} )} {d}^{2} ( {p}_{ij} , {P}_{i} ) v ( {p}_{i j} ) )$$

where v(pᵢⱼ) is the differential volume/importance of the point pᵢⱼ (e.g., importance field 600 in FIG. 6A) and d(Pᵢⱼ, Pᵢ) is the distance of pᵢⱼ to Pᵢ defined for all points in its Voronoi cell pᵢⱼ∈ [symbol] (Pᵢ). The overall problem then is to find the set of points {Pᵢ} satisfying:

$$arg {min}_{\{ {P}_{i} \}} {d}_{v}^{2} ( \{ {P}_{i} \} ) .$$

This is an unconstrained nonlinear optimization problem with 3n degrees of freedom.

The distance field can be specified differentially in terms of a spatially varying metric tensor (3×3 positive-definite and symmetric matrix) M(p), or more simply and isotropically via a scalar metric speed field:

$$M ( p ) = {m}^{2} ( p ) I$$

(e.g., energy propagation variation field 610 shown in FIG. 6B) where I is the identity matrix. Then the distance between any connected pair of points p₁ and p₂ is given by the path integral:

$$d ( {p}_{1} , {p}_{2} ) = {\int }_{𝒢 ( {p}_{1} , {p}_{2} )} d s$$

along the geodesic path [symbol] connecting them: the path having minimal distance d among all such paths. The differential path length at any point is given by:

$$d s ( t ) = m ( 𝒢 ( t ) ) ‖ \dot{𝒢} ( t ) ‖ dt$$

for some parameterization of the geodesic curve in terms of t, p(t)← [symbol] (t), and where [symbol] (t) is its tangent vector at t. The field m(p) thus represents speed of propagation of any arclength-parameterized geodesic path (i.e., parameterized such that ∥ [symbol] (t)∥=1 for all t) through the point p: the greater the speed, the greater the differential distance at p. For a general (anisotropic) metric, the differential distance formula generalizes to:

$$d s ( t ) = \sqrt{{( \dot{𝒢} ( t ) )}^{T} M ( 𝒢 ( t ) ) \dot{𝒢} ( t )} dt$$

which then depends on the tangent vector direction of the geodesic curve as well as its length.

The above assumes a discretization of the free space of the scene in terms of a set of points p. Then the precise definition of Voronoi cell is p∈ [symbol] (Pᵢ)⇒d(p, Pᵢ)≤d(p,Pₖ)∀k≠i. In words, p is in the Voronoi cell of Pᵢ if its distance to Pᵢ is no greater than its distance to any other sample point Pₖ, k≠i. In cases of a distance tie to multiple sample points at some point p, it is convenient to assume the Voronoi cells partition the free space and simply assign p to the Voronoi cell around the sample point having lowest index.

For computational purposes, the fields can be handled by a 3D discretization inside a grid around the scene of interest and given the scalar fields v(p) and m(p) for each point p in that discretization as input. The algorithm can also be given a binary field b(p) which indicates whether the point p is occupied by geometry that completely prevents transmission, removing that point from the scene's free space. Alternatively, such points can be marked via m(p)=0.

The distance field between Pᵢ and all points pᵢⱼ in its Voronoi neighborhood can be computed using the fast marching method (FMM) with inhomogeneous speed, which solves the partial differential equation (PDE):

$$‖ ∇ d ( p ) ‖ = m ( p )$$

or equivalently:

$$\frac{{‖ ∇ d ( p ) ‖}^{2}}{{m}^{2} ( p )} = 1 .$$

Let dⱼ*(p) be the vector of distances for the three immediate causal Manhattan neighbors of p in the grid (those neighbors in each of the coordinate directions having the smaller distance of the pair) denoted:

$${d}_{j}^{*} ( p ) ≡ min ( d ( {p}_{j}^{-} ) , d ( {p}_{j}^{+} ) )$$

where pⱼ⁻=p−eⱼ and pⱼ⁺≣p+eⱼ and where eⱼ is the unit coordinate axis: e₁=X=(1,0,0), e₂=Y=(0,1,0), and e₃=Z=(0,0,1) to get to the neighbor of p in the grid. Then the application of numerical derivatives to solve the PDE at a given p reduces to solving the following quadratic equation in d:

$${\sum }_{j = 1}^{3} \frac{{( d - {d}_{j}^{*} )}^{2}}{{h}^{2}} = {m}^{2}$$

where h is the grid size of the discretization. If the discriminant of the above quadratic equation is negative, or the resulting solution for D fails to satisfy causality; that is:

$$d < max ( {d}_{1}^{*} , {d}_{2}^{*} , {d}_{3}^{*} )$$

then the update is performed instead over all the 2D or 1D subspaces of its neighborhood to find the minimum, causality-satisfying d by solving the (dimension-reduced) quadratic equation:

$${\sum }_{j ∈ 𝒥} \frac{{( d - {d}_{j}^{*} )}^{2}}{{h}^{2}} = {m}^{2}$$

over a subset of indices [symbol] ⊂{1,2,3}.

The FMM algorithm initializes the distance of the source point to 0 and all other free points to be solved for to ∞. The FMM algorithm then visits points in order of increasing distance via a priority queue, starting from the source. After the next point is popped from the queue, the distances of its immediate neighbors in the grid in the free space and not already visited are updated via the above quadratic solution and then inserted onto the queue.

To handle the metric tensor M(p), note that the geodesic paths for all distances solved for go back to a fixed source point Pᵢ. Assuming all geodesic paths that hit p and then proceed backwards from p to the source have fixed tangent vector g (p), the resulting scalar speed there can be computed via:

$$m ( p ) = \sqrt{\frac{{( \dot{𝒢} ( p ) )}^{T} M ( p ) \dot{𝒢} ( p )}{\dot{𝒢} ( p ) \cdot \dot{𝒢} ( p )}} .$$

The distance field for a fixed source can be solved via the generalized PDE:

$${( ∇ d ( p ) )}^{T} {M}^{- 1} ( p ) ∇ d ( p ) = 1$$

yielding the following quadratic equation for updating d:

$${d}^{2} \vert {M}^{- 1} \vert - 2 d \vert {M}^{- 1} {d}^{*} \vert + {( {d}^{*} )}^{T} {M}^{- 1} {d}^{*} = {h}^{2}$$

where |M⁻¹|=ΣᵢⱼMᵢⱼ⁻¹ in the first term on the LHS and |v|=Σᵢvᵢ in the second term. Note also that (d*)^{T}M⁻¹ d*=ΣᵢⱼMᵢⱼdᵢ*dⱼ*.

As with the isotropic (scalar) metric, the quadratic discriminant sign and causality of its solution can be checked, and the update computed for a 2D or 1D subspace if that check fails. The relevant subspaces to check respects the metric's orientation which can be exposed by diagonalizing it via:

M=R^{T}DR

where R is a 3D rotation matrix, and D is a diagonal matrix with positive diagonal elements. Then:

$${M}^{- 1} = {R}^{T} {D}^{- 1} R$$

and the (2D or 1D) subspaces are given by zeroing out (1 or 2) elements of diagonal matrix D⁻¹.

The greater the differential importance (v) or differential distance (m) at some location p, the higher the sampling density there and thus the more likely placement of samples in its vicinity. While v directly controls differential importance, m specifies the differential geodesic path length in each Voronoi cluster. In other words, D_{V} involves two nested integrals where v is the differential volume element for the outer integral, and m is the differential path length (speed) in the inner integral. Both can be considered independent and spatially varying. Another perspective is that m(p) specifies how the presence of the scene geometry itself affects (intrinsic) distances within the scene while v(p) indicates importance information extrinsic to the scene.

From dᵥ² above, define the RMS distance for the entire sample point set via:

$${\overline{d}}_{v} ≡ \sqrt{{d}_{v}^{2}}$$

and normalize out the total volume contribution to define:

$$\overline{d} ≡ \sqrt{\frac{{d}_{v}^{2}}{{v}^{*}}}$$

where v* is the total volume of the scene:

$${v}^{*} ≡ {\sum }_{i = 1}^{n} {\int }_{𝒞 ( {P}_{i} )} d v = {\sum }_{i = 1}^{n} ( {\sum }_{{p}_{ij} ∈ 𝒞 ( {P}_{i} )} v ( {p}_{ij} ) ) .$$

This is a useful measure of the average “radius” of the Voronoi cells induced by the samples.

A generalization of Lloyd's algorithm can be applied to solve the centroidal Voronoi tessellation problem posed above that refines an initial set of sample points by reducing dᵥ at each step in the iteration. Each relaxation iteration consists of two steps. The first assigns each point in the free space to the Voronoi cell of its closest sample point Pᵢ (adjusting assignment of points to Voronoi cells with a fixed set of sample points). The second updates the sample point in each Voronoi cell to minimize squared distance summed over all its members to an updated “center” Pᵢ (adjusting the Pᵢ given a fixed assignment of points to Voronoi cells). Both steps reduce dᵥ. Once the sample point is updated, a new FMM is computed solving for and storing geodesic distance at every point pᵢⱼ in its Voronoi cell to that new center, and the next iteration can proceed. The algorithm is terminated when no further reduction in dᵥ can be found.

To reduce computation, compute the FMM for each Voronoi cell within a box around its currently assigned members, grown by one cell to allow for possible expansion in the next iteration. Note that in the standard Lloyd's algorithm using simple Euclidean distance, the update step can be computed analytically as the average of all its members. With geodesic distance, the simple mean no longer provides minimal summed distance. Instead, the update step applies numerical descent from the current sample point using the computed sum of squared distances to all points in its Voronoi cell, by iteratively checking neighbors of the current sample to find one that reduces that distance.

The algorithm can be initialized with a greedy, bottom-up pairwise merging, discussed more below, starting from the individual discretized points pᵢⱼ, stopping when the merge yields n clusters. The initial sample point in each cluster is taken as the cluster member closest to the cluster's Euclidean mean. Given n, the overall algorithm computes the initial pairwise merge and then applies Lloyd relaxation until convergence.

Rather than specifying n, it can be useful to specify a target for the RMS distance d̅ᵥ or d̅ defined above. This can be accomplished by an outer loop around the entire computation outlined above which optimizes {Pᵢ} given n and then computes the resulting d̅. The specified n can then be relaxed to yield a targeted d within some error tolerance.

### Intialization Details

The following describes in further detail the initial clustering step for the probe layout problem described above. Recall that the overall problem seeks n optimal sample points, Pᵢ: i∈[1,n], which minimize integrated, importance-weighted distance squared defined as:

$${d}_{v}^{2} ( \{ {P}_{i} \} ) ≡ {\sum }_{i = 1}^{n} ( {\sum }_{{p}_{ij} ∈ 𝒞 ( {P}_{i} )} {d}^{2} ( {p}_{ij} , {P}_{i} ) v ( {p}_{ij} ) )$$

where v(pᵢⱼ) is the differential volume/importance of the point pᵢⱼ and d(pᵢⱼ,Pᵢ) is the distance of pᵢⱼ to Pᵢ defined for all points in its Voronoi cell pᵢⱼ∈ [symbol] (Pᵢ). A 3D scalar field of differential volume v(pᵢⱼ) and differential distance m(pᵢⱼ) (used to define the total geodesic distance d(p₁, p₂) between any two points p₁ and p₂) is given as overall input.

The initial merge algorithm is also given as input a target Euclidean RMS distance (see below) or a target number of clusters n. Beginning at the individual discretized grid points pᵢⱼ, the algorithm merges the next neighboring pair having lowest cost from a priority queue (PQ) of pairs. Here, “neighbors” here means that one cluster in the pair contains at least one grid point that is a direct Manhattan neighbor to some point in the other cluster.

After the merger of the highest priority pair Q= [symbol] A, B [symbol] , update Q's list of neighbors from among the neighbors of A and B, and insert pairs consisting of Q with each of its neighbors in the PQ. Note that once A and B are merged, all other pairs [symbol] A, C [symbol] ∀C≠B and [symbol] B,D [symbol] ∀D≠A become invalid mergers. Some implementations do not remove them from the PQ, since PQ removal is efficient only for the top (highest priority) pair. Instead, leave them on the PQ. Each node stores a “parent” pointer recording the direct merged node (that is, A.parent=Q and B.parent=Q after their merger to Q), or a null pointer for nodes not yet merged. When the next potential pair is popped off the PQ, check that both nodes in the pair have null parent pointers, and discard the pair if either has a non-null parent and thus has already been merged.

Ideally, the initialization would merge each pair which, after its merger, contributes the least increment to the overall objective above. That is, seek to merge parent Q having the smallest volume-weighted sum of distances over Q to the Q's center minus the volume-weighted sum of distances over its two child clusters A and B. Because distance is computed with respect to a complicated, spatially-varying metric, this ideal cost can be approximated by assuming a constant, average metric over Q and a cluster center given by the Euclidean (rather than a geodesic) mean of its member points. Each node stores its integrated volume, its volume-weighted centroid (Euclidean mean), its volume-weighted length squared, and its volume-weighted average metric squared:

$$A . v = {\sum }_{{p}_{i} ∈ A} v ( {p}_{i} )$$

$$A . p = {\sum }_{{p}_{i} ∈ A} {p}_{i} v ( {p}_{i} ) / A . v$$

$$A . {l}^{2} = {\sum }_{{p}_{{i}^{∈ A}}} {‖ {p}_{i} ‖}^{2} v ( {p}_{i} ) / A . v$$

$$A . {m}^{2} = {\sum }_{{p}_{i} ∈ A} {m}^{2} ( {p}_{i} ) v ( {p}_{i} ) / A . v$$

Then the average squared distance over all points in the cluster A to any point p can be computed efficiently from these stored quantities via:

$$A ( p ) ≡ {\sum }_{{p}_{i} ∈ A} {‖ {p}_{i} - p ‖}^{2} v ( {p}_{i} ) = {\sum }_{{p}_{i} ∈ A} {‖ {p}_{i} ‖}^{2} v ( {p}_{i} ) - 2 p \cdot {\sum }_{{p}_{i} ∈ A} {p}_{i} v ( {p}_{i} ) + {‖ p ‖}^{2} {\sum }_{{p}_{i} ∈ A} v ( {p}_{i} ) = ( A . {l}^{2} + 2 p . A . p + {‖ p ‖}^{2} ) A v .$$

The above quantities can be maintained incrementally through the merge operation without resorting to a sum over all children of the merged node. After a merger, apply the following rules to compute them for the merged parent node from its children:

$$Q . v = A . v + B . v$$

$$Q . p = ( A . p A . v + B . pB . v ) / Q . v$$

$$Q . {l}^{2} = ( A . {l}^{2} A . v + B . {l}^{2} B . v ) / Q . v$$

$$Q . {m}^{2} = ( A . {m}^{2} A . v + B . {m}^{2} B . v ) / Q . v$$

Note that the bottom three quantities are simply the respective volume-weighted results renormalized by total volume. The final priority is given by:

$$Q ( Q . p ) Q . {m}^{2} - ( A ( A . p ) A . {m}^{2} + B ( B . p ) B . {m}^{2} )$$

which takes squared distance weighted by average squared metric of the merger minus that same quantity summed over the two child nodes. Because of the approximations involved with average metrics, the formula above can actually go negative, so take a max of it with 0.

Mergers considered by this algorithm may involve one or both nodes having zero total volume. To avoid division by zero, consider the total number of discrete points in such nodes as a proxy volume. In addition, flag their cost as negative so that zero-volume pairs are merged first, before any non-zero volume mergers can be considered.

To speed up the algorithm, an initial clustering can be performed by first grouping k×k×k discrete leaf node points that are unoccupied (points or voxels having air) and flood-fill reachable to each other. This is much faster than the bottom-up merge when there are many leaf node points. Further mergers are then computed from these initial clusters.

The algorithm proceeds until the desired number of merged clusters is produced, or the following sum over all merged clusters:

$${\sum }_{j} {Q}_{j} ( {Q}_{j} . p ) {Q}_{j} . {m}^{2}$$

first exceeds a threshold. The above sum is an approximation of the distance squared objective for the overall layout problem, except it replaces geodesic distance with Euclidean distance multiplied by the average metric squared. The sum can be maintained by first computing it over all the initial clusters (leaves or grouped leaves for fast initial clustering above), and then adding up the PQ cost of all mergers computed thereafter.

For termination based on a specified number of clusters n, note that each merger decreases the number of clusters by one, since a former pair of nodes is replaced by a single node. Beginning with the initial clusters N (again, the total number of leaves, or grouped leaves for fast initial clustering above), decrement N after each merger until it equals the specified n.

### Example Experimental Results

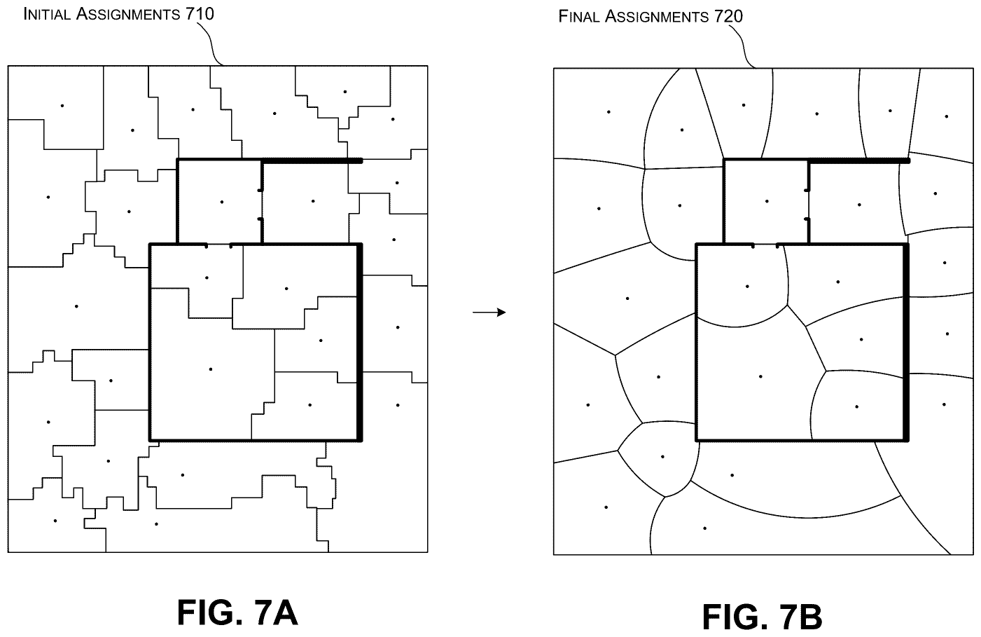

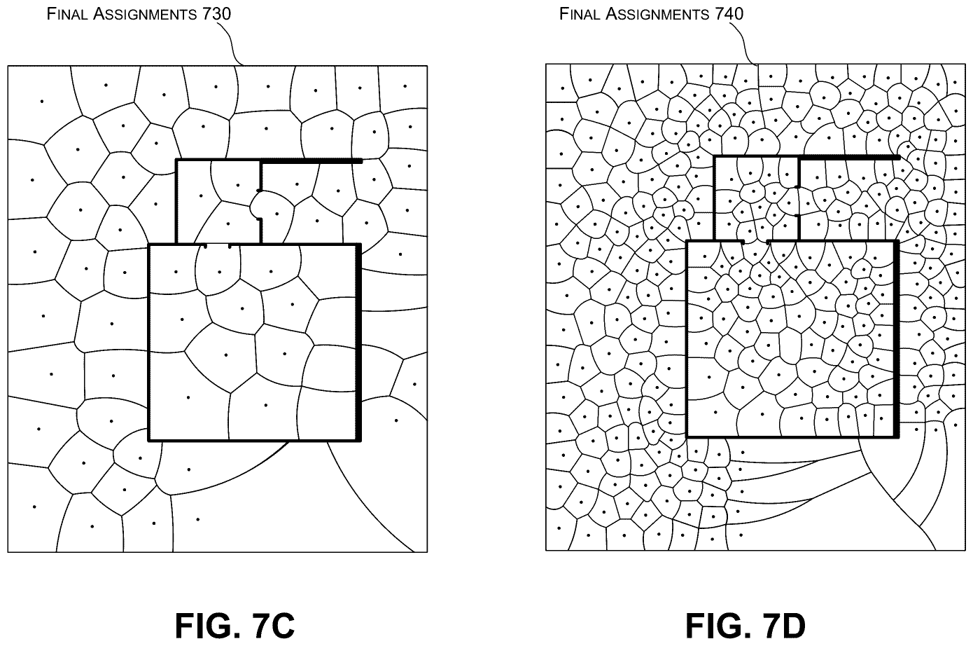

The algorithm described above was implemented on the scene shown in FIG. 5. FIG. 7A shows an example of initial assignments 710 computed using the greedy, bottom-up pairwise merging technique described above. Each black dot shown in FIG. 7A represents the initialized location of a sampling probe, and the surrounding cell represents all points within the initial sampling assignment for that sampling probe.

FIG. 7B shows an example of final assignments 720 after relaxation is performed on the initialized assignments shown in FIG. 7A. Note that the location of the sampling probes is relatively consistent, because the importance field largely controls where the sampling probes are located. However, the shape of the cells changes significantly during relaxation based on the geodesic distance of each point from the respective sampling probes.

FIG. 7C shows an example of final assignments 730 after initialization and relaxation at a medium granularity, and FIG. 7D shows an example of final assignments 740 after initialization and relaxation at a fine granularity. Referring back to importance field 600 shown in FIG. 6A, there is a large portion of area 602 in the lower-right corner of the importance field with relatively low importance. This influences the size of the corresponding cells of the final assignments, e.g., the cells in the lower-right corner of FIG. 7D are much larger than the remaining cells. Also, note that the cells tend to be denser near outside corners and portals, and relatively less dense further away from these geometric features. Said another way, the final sampling assignments tend to result in greater sampling densities for either (1) areas with relatively higher importance or (2) areas near geometric features, such as portals and outside corners, that tend to strongly influence energy propagation.

### Example System

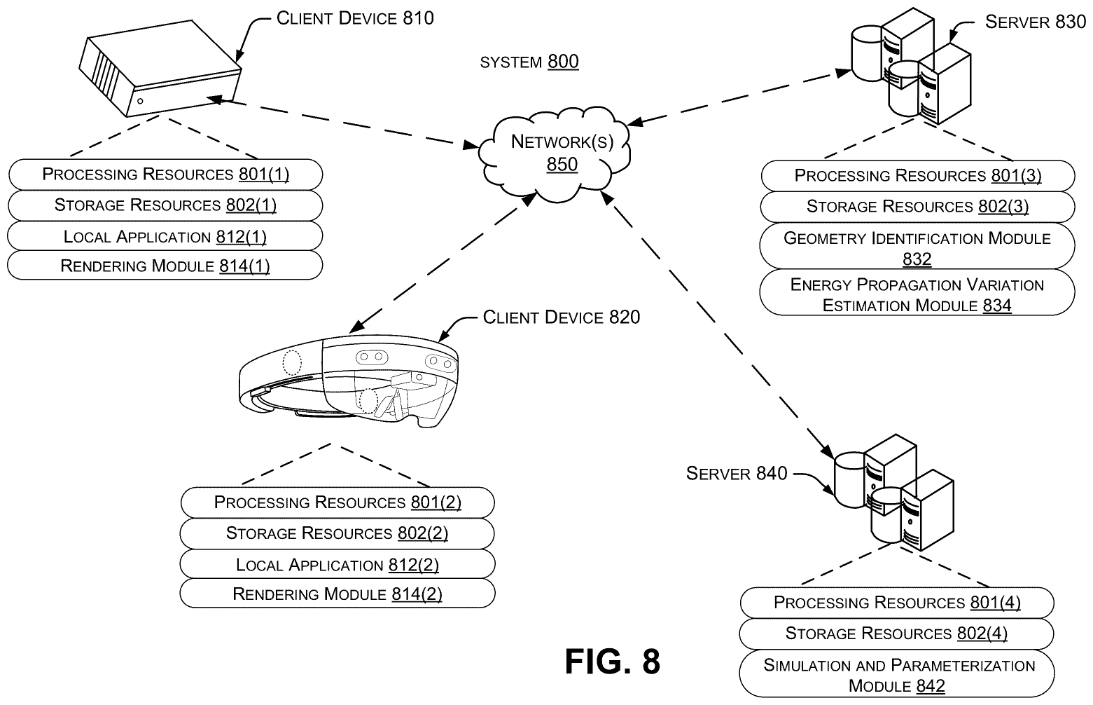

The present implementations can be performed in various scenarios on various devices. FIG. 8 shows an example system 800 in which the present implementations can be employed, as discussed more below.

As shown in FIG. 8, system 800 includes a client device 810 (e.g., a video game console), a client device 820 (e.g., a virtual or augmented reality headset), a server 830, and a server 840, connected by one or more network(s) 850. Note that the client devices can also be embodied in other mobile device form factors such as laptops, tablets, or mobile phones, and/or as stationary devices such as desktops. Likewise, the servers can be implemented using various types of computing devices. In some cases, any of the devices shown in FIG. 8, but particularly the servers, can be implemented in data centers, server farms, etc.

Certain components of the devices shown in FIG. 8 may be referred to herein by parenthetical reference numbers. For the purposes of the following description, the parenthetical (1) indicates an occurrence of a given component on client device 810, (2) indicates an occurrence of a given component on client device 820, (3) indicates an occurrence on server 830, and (4) indicates an occurrence on server 840. Unless identifying a specific instance of a given component, this document will refer generally to the components without the parenthetical.

Generally, the devices 810, 820, 830, and/or 840 may have respective processing resources 801 and storage resources 802, which are discussed in more detail below. The devices may also have various modules that function using the processing and storage resources to perform the techniques discussed herein. The storage resources can include both persistent storage resources, such as magnetic or solid-state drives, and volatile storage, such as one or more random-access memory devices. In some cases, the modules are provided as executable instructions that are stored on persistent storage devices, loaded into the random-access memory devices, and read from the random-access memory by the processing resources for execution.

Client devices 810 and 820 can include a local application 812, such as a video game, an augmented/virtual reality game, an architectural design application, etc. The local application can invoke a rendering module 814 to render audio and/or graphics at runtime based on precomputed parameters received from server 840, as described more below.

Server 830 can include a geometry identification module 832 that identifies geometric features such as outside corners and portals. Server 830 can also include an energy propagation variation estimation module 834. The energy propagation variation estimation module can employ the identified geometric features to generate fields reflecting how energy propagation varies as a function of location in space within scene(s) provided by the local application. In some implementations, the energy propagation values are obtained by identifying outside corners and portals, e.g., as identified by an application developer. Then, a negative log value of the distance of each point in a given scene from the nearest outside corner or portal can be used as an estimate of energy propagation variation at that point.

Server 840 can include a simulation and parameterization module. The simulation and parameterization module can receive identified geometric features and/or energy propagation fields from server 830 and simulate energy propagation in the scenes. Parameters representing characteristics of energy propagation can be derived from the simulations and provided with the scenes for use by the rendering module on the respective client devices.

### First Example Method

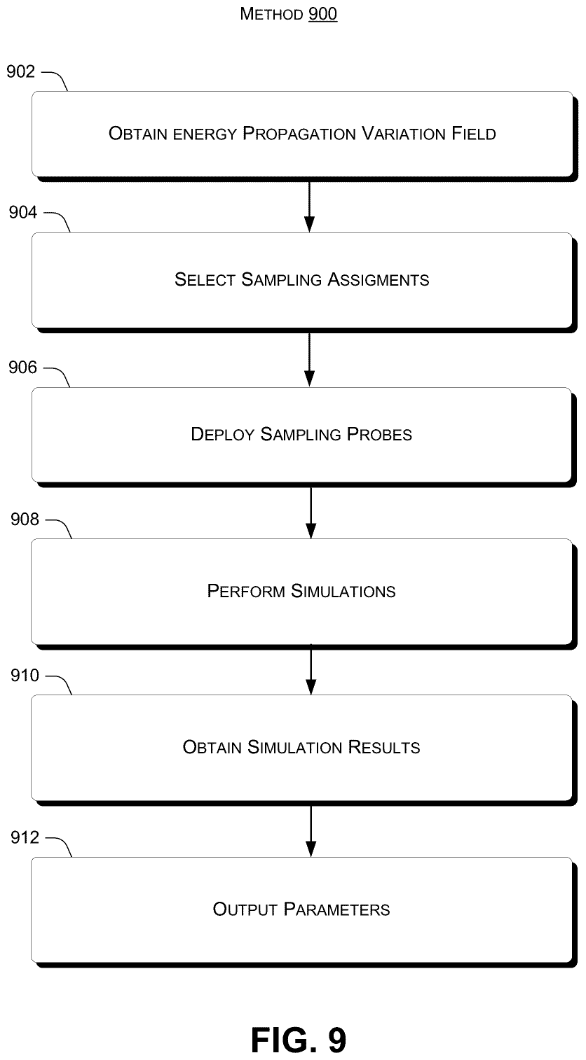

FIG. 9 shows a method 900 that can be employed to adaptively sample energy propagation characteristics in a three-dimensional synthetic scene. For instance, method 900 can be performed by simulation and parameterization module 842 on server 840.

Method 900 begins at block 902, where an energy propagation variation field is obtained. The energy propagation variation field can have energy propagation variation values indicating rates at which energy propagation changes as a function of location within a three-dimensional synthetic scene. In some implementations, block 902 can also involve obtaining an importance weighting field having importance weights indicating the relative importance of sampling as a function of location within the three-dimensional synthetic scene.

Method 900 continues at block 904, where sampling assignments are determined. For instance, as noted above, a greedy, bottom-up pairwise merging based on Euclidean distance can be performed to identify initial sampling probe locations and cells of points assigned to each sampling probe. Then, a relaxation technique can be employed to adjust the shape of the cells, resulting in a final set of sampling assignments.

Method 900 continues at block 906, where sampling probes are deployed. For instance, acoustic or light probes can be placed at the sampling probe locations determined at block 906.

Method 900 continues at block 908, where simulations are performed using the deployed sampling probes. For acoustic probes, a time-domain wave solver can be used to compute sound wave travel in the three-dimensional virtual scene according to the acoustic wave equation. For graphics applications, two dimensional maps of incident radiance at a camera/receiver represented by the sampling probe can be provided to represent propagation of globally fixed lighting.

Method 900 continues at block 910, where results of the simulations are obtained. For acoustic probes, the results can include initial sound parameters such as the loudness of the initial sound path, the departure direction of the initial sound path from the source, the arrival direction of the initial sound path at the receiver, etc. For light probes, parameters can be stored representing how light energy arrives at the sampled locations, such as intensity of different wavelengths arriving at the sampled locations, wavelength basis functions at the sampled locations, or human cone response functions at the sampled locations.

Method 900 continues at block 912, where the parameters are stored. For instance, block 912 can involve quantizing the parameters and compressing the quantized parameters, e.g., using delta encoding. The compressed parameters can provide a basis for subsequent runtime rendering of energy propagation within the three-dimensional synthetic scene.

### Second Example Method

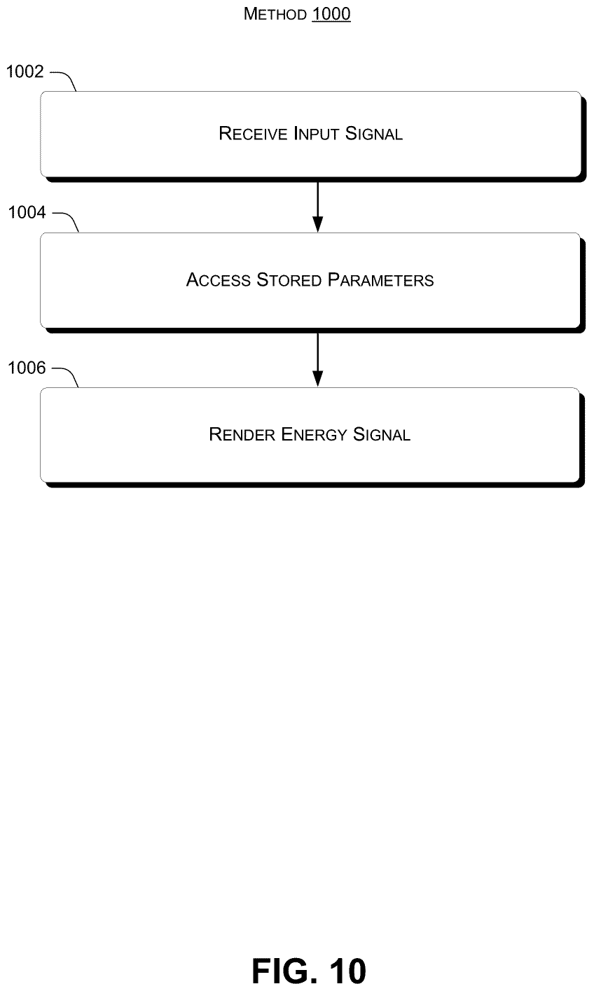

FIG. 10 shows a method 1000 that can be employed to render an energy signal. For instance, method 1000 can be performed by rendering module 814 on client device 810 and/or 820.

Method 1000 begins at block 1002, where an input signal having a corresponding runtime source location in a three-dimensional synthetic scene is received. For instance, the input signal can be a time-domain representation of a sound that has multiple frequency components and corresponding magnitudes and phases. Block 1002 can also involve receiving a location of a receiver (e.g., a listener) in the three-dimensional synthetic scene.

Method 1000 continues at block 1004, where stored parameters that convey characteristics of energy propagation within the three-dimensional synthetic scene are accessed. For instance, the stored parameters can have been obtained previously by simulating energy propagation at sampled locations in the three-dimensional synthetic scene. The sampled locations can be located based at least on an energy propagation variation field and an importance field.

Method 1000 continues at block 1006, where the input signal and the parameters are used to render an energy signal at the receiver location. For instance, parameters for probed locations near the receiver location can be interpolated (e.g., using Shepard interpolation) to determine parameters for the source/receiver pair.

### Example Rendering of Initial Sound

As noted above, one type of energy that can be rendered using the disclosed techniques is sound energy. In some implementations, a received sound signal can convey directional characteristics of a runtime sound source, e.g., via a source directivity function (SDF). In addition, listener data can convey a location of a runtime listener and an orientation of the listener. The listener data can also convey directional hearing characteristics of the listener, e.g., in the form of a head-related transfer function (HRTF).

Initial sound can be rendered by modifying the input sound signal to account for both runtime source and runtime listener location and orientation. For instance, given the runtime source and listener locations, the rendering can involve identifying and interpolating the following encoded parameters that were precomputed using probes that are near the runtime listener location-initial delay time, initial loudness, departure direction, and arrival direction. The directivity characteristics of the sound source (e.g., the SDF) can encode frequency-dependent, directionally-varying characteristics of sound radiation patterns from the source. Similarly, the directional hearing characteristics of the listener (e.g., HRTF) encode frequency-dependent, directionally-varying sound characteristics of sound reception patterns at the listener.

The sound source data for the input event can include an input signal, e.g., a time-domain representation of a sound such as series of samples of signal amplitude (e.g., 44100 samples per second). The input signal can have multiple frequency components and corresponding magnitudes and phases. In some implementations, the input time-domain signal is processed using an equalizer filter bank into different octave bands (e.g., nine bands) to obtain an equalized input signal.

Next, a lookup into the SDF can be performed by taking the encoded departure direction and rotating it into the local coordinate frame of the input source. This yields a runtime-adjusted sound departure direction that can be used to look up a corresponding set of octave-band loudness values (e.g., nine loudness values) in the SDF. Those loudness values can be applied to the corresponding octave bands in the equalized input signal, yielding nine separate distinct signals that can then be recombined into a single SDF-adjusted time-domain signal representing the initial sound emitted from the runtime source. Then, the encoded initial loudness value can be added to the SDF-adjusted time-domain signal.

The resulting loudness-adjusted time-domain signal can be input to a spatialization process to generate a binaural output signal that represents what the listener will hear in each ear. For instance, the spatialization process can utilize the HRTF to account for the relative difference between the encoded arrival direction and the runtime listener orientation. This can be accomplished by rotating the encoded arrival direction into the coordinate frame of the runtime listener's orientation and using the resulting angle to do an HRTF lookup. The loudness-adjusted time-domain signal can be convolved with the result of the HRTF lookup to obtain the binaural output signal. For instance, the HRTF lookup can include two different time-domain signals, one for each ear, each of which can be convolved with the loudness-adjusted time-domain signal to obtain an output for each ear. The encoded delay time can be used to determine the time when the listener receives the individual signals of the binaural output.

Using the approach discussed above, the SDF and source orientation can be used to determine the amount of energy emitted by the runtime source for the initial path. For instance, for a source with an SDF that emits relatively concentrated sound energy, the initial path might be louder relative to the reflections than for a source with a more diffuse SDF. The HRTF and listener orientation can be used to determine how the listener perceives the arriving sound energy, e.g., the balance of the initial sound perceived for each ear.

### Further Implementations

As noted above, some implementations can specify a target root mean square (RMS) distance for each probe from the points within its assigned cell. In further implementations, different target RMS values can be assigned (e.g., by a developer) for different areas within a synthetic three-dimensional scene. Consider a scenario where a video game developer knows in advance that users are likely to occupy a specific building in a virtual scene more frequently than another area. One way for the developer to influence the sampling density in that building is to use the importance field described above. However, by specifying a target RMS distance for the building instead, the developer can have more direct control over sampling density.

In addition, the disclosed techniques can be extended to solve other problems involving propagation of energy. For instance, consider a network coverage problem, where the goal is to deploy relatively few cellular towers to provide service to many users. By considering the geodesic distance of the towers to locations where users will be as well as the probability that a user will be at each location, cellular towers can be distributed as described above with respect to sampling probes. Other types of radio-frequency transmitters, such as AM or FM radio or television signals, can also be positioned in a similar manner.

### Technical Effect

As noted previously, one way to sample a three-dimensional synthetic scene involves uniform sampling. While uniform sampling can, given adequate resolution, allow for high-quality rendering of energy signals at runtime, it can be computationally intensive. For instance, in some implementations, each simulation is performed by a different virtual machine having its own processing and memory resources. Using the disclosed techniques, in some cases the number of virtual machines can be reduced by 50% or more without losing fidelity of runtime rendering. In addition, the memory and storage requirements for simulated parameters can also be reduced significantly, e.g., by 50% or more. Thus, at runtime, memory utilization of a computing device for rendering purposes can be reduced.

Furthermore, uniform sampling can also result in certain areas being under-sampled. For instance, consider a narrow hallway with 50 portals, where adequately sampling the hallway could involve at least 50 sampling probes but a uniform sampling distribution would result in only 10 sampling probes in the hallway. Even doubling the uniform sampling resolution is not sufficient to adequately sample every portal in the hallway, and numerous portals will go unsampled. The disclosed techniques can ensure that all of the portals are sampled. As a consequence, because parameters are sampled for every portal, a realistic rendering experience can be provided at runtime that would not be plausible using uniform sampling that does not sample all of the portals.

### Device Implementations

As noted above with respect to FIG. 8, system 800 includes several devices, including a client device 810, a client device 820, a server 830, and a server 840. As also noted, not all device implementations can be illustrated, and other device implementations should be apparent to the skilled artisan from the description above and below.

The term “device”, “computer,” “computing device,” “client device,” and or “server device” as used herein can mean any type of device that has some amount of hardware processing capability and/or hardware storage/memory capability. Processing capability can be provided by one or more hardware processors (e.g., hardware processing units/cores) that can execute data in the form of computer-readable instructions to provide functionality. Computer-readable instructions and/or data can be stored on storage, such as storage/memory and or the datastore. The term “system” as used herein can refer to a single device, multiple devices, etc.

Storage resources can be internal or external to the respective devices with which they are associated. The storage resources can include any one or more of volatile or non-volatile memory, hard drives, flash storage devices, and/or optical storage devices (e.g., CDs, DVDs, etc.), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

In some cases, the devices are configured with a general purpose hardware processor and storage resources. Processors and storage can be implemented as separate components or integrated together as in computational RAM. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.). Devices can also have various output mechanisms such as printers, monitors, etc.

Also note that the devices described herein can function in a stand-alone or cooperative manner to implement the described techniques. For example, the methods and functionality described herein can be performed on a single computing device and/or distributed across multiple computing devices that communicate over network(s) 850. Without limitation, network(s) 850 can include one or more local area networks (LANs), wide area networks (WANs), the Internet, and the like.

### Additional Examples

Various examples are described above. One example can include a computer-implemented method comprising obtaining an energy propagation variation field having energy propagation variation values indicating rates at which energy propagation changes as a function of location within a three-dimensional synthetic scene, selecting a plurality of sampling assignments within the three-dimensional synthetic scene based at least on the energy propagation variation field, deploying sampling probes within the three-dimensional synthetic scene according to the plurality of sampling assignments, performing simulations of energy propagation within the three-dimensional synthetic scene using the deployed sampling probes, obtaining results of the simulations, and storing parameters corresponding to the results of the simulations, the parameters providing a basis for subsequent rendering of an energy signal within the three-dimensional synthetic scene.

Another example can include any of the above and/or below examples where the method further comprises obtaining an importance weighting field having importance weights indicating the relative importance of sampling as a function of location within the three-dimensional synthetic scene and selecting the plurality of sampling assignments based at least on the importance weighting field.

Another example can include any of the above and/or below examples where the importance weighting field conveying a relative probability of a user is located at a particular location within the three-dimensional synthetic scene.

Another example can include any of the above and/or below examples where the sampling assignments comprises sampling probe locations and points assigned to each respective sampling probe.

Another example can include any of the above and/or below examples where the sampling assignments are selected based at least on an aggregated importance-weighted distance function calculated using the energy propagation variation field and the importance weighting field.

Another example can include any of the above and/or below examples where the sampling assignments are selected by assigning points in the three-dimensional synthetic scene to cells of respective sampling probe locations.

Another example can include any of the above and/or below examples where the method further comprises initializing the plurality of sampling assignments based on a Euclidean distance function.

Another example can include any of the above and/or below examples where the initializing comprises determining a specified number of the cells based at least on a target sampling distance or a target number of sampling probes.

Another example can include any of the above and/or below examples where the initializing comprises iteratively merging points in the three-dimensional synthetic scene into cells according to a cost function until the specified number of cells are generated.

Another example can include any of the above and/or below examples where the cost function is evaluated using the energy propagation variation field and the importance weighting field.

Another example can include any of the above and/or below examples where the method further comprises iteratively relaxing the cells until convergence.

Another example can include any of the above and/or below examples where the iteratively relaxing comprises assigning points in the three-dimensional synthetic scene to cells of the closest sampling probe locations and updating the sampling probe locations based on relative distance of the sampling points to respective points in respective cells assigned to the sampling probe locations.

Another example can include any of the above and/or below examples where updating the sampling probe locations is performed based on a sum of squared geodesic distances to the respective points.

Another example can include any of the above and/or below examples where the method further comprises receiving at least two different target sampling spacing distances for at least two different areas of the three-dimensional synthetic scene and selecting respective sampling assignments for the at least two different areas with different sampling densities according to the at least two different target sampling spacing distances.

Another example can include any of the above and/or below examples where the energy propagation variation field includes scalar values characterizing the energy propagation isotopically or matrices characterizing the energy propagation anisotropically.

Another example includes a system comprising a processor and storage storing computer-readable instructions which, when executed by the processor, cause the system to receive an input signal having a source location in a three-dimensional synthetic scene, access parameters that convey characteristics of energy propagation within in the three-dimensional synthetic scene, the parameters having been obtained by simulating energy propagation at sampled locations in the three-dimensional synthetic scene, the sampled locations being located based at least on an energy propagation variation field and an importance field, and render an energy signal at a receiver location based at least on the parameters.

Another example can include any of the above and/or below examples where the computer-readable instructions, when executed by the processor, cause the system to perform interpolation of the parameters based on distances from individual sampled locations to the receiver location.

Another example can include any of the above and/or below examples where the energy signal is a sound signal, and the parameters convey loudness of initial sound arriving at the sampled locations from other locations in the three-dimensional synthetic scene.

Another example can include any of the above and/or below examples where the energy signal is a light signal, and the rendering comprises rendering an image with lighting based on the parameters. Another example includes a computer-readable medium storing executable instructions which, when executed by a processor, cause the processor to perform acts comprising obtaining an energy propagation variation field having energy propagation variation values indicating rates at which energy propagation changes as a function of location within a three-dimensional synthetic scene, selecting a plurality of sampling assignments within the three-dimensional synthetic scene based at least on the energy propagation variation field, deploying sampling probes within the three-dimensional synthetic scene according to the plurality of sampling assignments, performing simulations of energy propagation within the three-dimensional synthetic scene using the sampling probes, obtaining results of the simulations, and storing parameters corresponding to the results of the simulations, the parameters providing a basis for subsequent rendering of energy within the three-dimensional synthetic scene.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A computer-implemented method comprising:
obtaining an energy propagation variation field having energy propagation variation values indicating rates at which energy propagation changes as a function of location within a three-dimensional synthetic scene;
selecting a plurality of sampling assignments within the three-dimensional synthetic scene based at least on the energy propagation variation field;
deploying sampling probes within the three-dimensional synthetic scene according to the plurality of sampling assignments;
performing simulations of energy propagation within the three-dimensional synthetic scene using the deployed sampling probes;
obtaining results of the simulations; and
storing parameters corresponding to the results of the simulations, the parameters providing a basis for subsequent rendering of an energy signal within the three-dimensional synthetic scene.

2. The method of claim 1, further comprising:
obtaining an importance weighting field having importance weights indicating the relative importance of sampling as a function of location within the three-dimensional synthetic scene; and
selecting the plurality of sampling assignments based at least on the importance weighting field.

3. The method of claim 2, the importance weighting field conveying a relative probability of a user being located at a particular location within the three-dimensional synthetic scene.

4. The method of claim 2, the sampling assignments comprising sampling probe locations and points assigned to each respective sampling probe.

5. The method of claim 4, wherein the sampling assignments are selected based at least on an aggregated importance-weighted distance function calculated using the energy propagation variation field and the importance weighting field.

6. The method of claim 5, wherein the sampling assignments are selected by assigning points in the three-dimensional synthetic scene to cells of respective sampling probe locations.

7. The method of claim 6, further comprising:
initializing the plurality of sampling assignments based on a Euclidean distance function.

8. The method of claim 7, the initializing comprising:
determining a specified number of the cells based at least on a target sampling distance or a target number of sampling probes.

9. The method of claim 8, the initializing comprising:
iteratively merging points in the three-dimensional synthetic scene into cells according to a cost function until the specified number of cells are generated.

10. The method of claim 9, the cost function being evaluated using the energy propagation variation field and the importance weighting field.

11. The method of claim 9, further comprising:
iteratively relaxing the cells until convergence.

12. The method of claim 11, wherein the iteratively relaxing comprises:
assigning points in the three-dimensional synthetic scene to cells of the closest sampling probe locations; and
updating the sampling probe locations based on relative distance of the sampling points to respective points in respective cells assigned to the sampling probe locations.

13. The method of claim 12, wherein updating the sampling probe locations is performed based on a sum of squared geodesic distances to the respective points.

14. The method of claim 2, further comprising:
receiving at least two different target sampling spacing distances for at least two different areas of the three-dimensional synthetic scene; and
selecting respective sampling assignments for the at least two different areas with different sampling densities according to the at least two different target sampling spacing distances.

15. The method of claim 1, wherein the energy propagation variation field includes scalar values characterizing the energy propagation isotropically or matrices characterizing the energy propagation anisotropically.

16. A system, comprising:
a processor; and
storage storing computer-readable instructions which, when executed by the processor, cause the system to:
receive an input signal having a source location in a three-dimensional synthetic scene;
access parameters that convey characteristics of energy propagation within in the three-dimensional synthetic scene, the parameters having been obtained by simulating energy propagation at sampled locations in the three-dimensional synthetic scene, the sampled locations being located based at least on an energy propagation variation field and an importance field; and
render an energy signal at a receiver location based at least on the parameters.

17. The system of claim 16, wherein the computer-readable instructions, when executed by the processor, cause the system to:
perform interpolation of the parameters based on distances from individual sampled locations to the receiver location.

18. The system of claim 17, wherein the energy signal is a sound signal, and the parameters convey loudness of initial sound arriving at the sampled locations from other locations in the three-dimensional synthetic scene.

19. The system of claim 17, wherein the energy signal is a light signal, and the rendering comprises rendering an image with lighting based on the parameters.

20. A computer-readable medium storing executable instructions which, when executed by a processor, cause the processor to perform acts comprising:
obtaining an energy propagation variation field having energy propagation variation values indicating rates at which energy propagation changes as a function of location within a three-dimensional synthetic scene;
selecting a plurality of sampling assignments within the three-dimensional synthetic scene based at least on the energy propagation variation field;
deploying sampling probes within the three-dimensional synthetic scene according to the plurality of sampling assignments;
performing simulations of energy propagation within the three-dimensional synthetic scene using the sampling probes;
obtaining results of the simulations; and
storing parameters corresponding to the results of the simulations, the parameters providing a basis for subsequent rendering of energy within the three-dimensional synthetic scene.
